(19) United States
(12) Patent Application Publication
(10) Pub. No.: US 2009/0165027 A1
(43) Pub. Date: Jun. 25, 2009

(54) Rack Structure in an Optical Disk Drive

(75) Inventor: Jen-Chen Wu, Guishan Shiang (TW)

Correspondence Address: NIKOLAI & MERSEREAU, P.A., 900 SECOND AVENUE SOUTH, SUITE 820, MINNEAPOLIS, MN, 55402, US

(73) Assignee: Quanta Storage Inc., Guishan Shiang (TW)

(21) Appl. No.: 12/264,686

(22) Filed: Nov. 4, 2008

(30) Foreign Application Priority Data
Dec. 25, 2007 (TW) 096150417

(51) Int. Cl. G11B 33/02; A47F 7/00

(52) U.S. Cl. 720/600; 211/26; G9B/33.002

(57) ABSTRACT

The invention is to provide a rack structure in an optical disk drive, which is formed integrally by pressing a metal plate. A connecting fixing part is disposed on a body. A brace is formed by bending down a periphery of the body. A convex or a concave trench is pressed near a front end of the body to form a secondary reinforcement. A reinforcement is formed by bending down near the middle of the front end of the body An elastic support is extended from the front end of the reinforcement and bent parallel to the front end of the body. A space is maintained between the elastic support and the body. A horizontal slot is pressed in the middle of the elastic support to form an upper support and a lower support. A first rack is disposed on one end connecting the upper support, of the lower support. The other end of the lower support is extended from the reinforcement to form a bending pivot. A second rack is formed on the other end of the upper support to enhance the engagement with the screw.

### FIELD OF THE INVENTION

The present invention relates to an optical disk drive, in particular to a rack structure which engages with the gearing screw in the gearing mechanism of an optical disk drive for driving the pick-up head moving back and forth.

### BACKGROUND OF THE INVENTION

Gearing mechanism of an optical disk drive moves the pick-up head to a precise position so the light beam emitted by the pick-up head can precisely focus on the tiny data marks on an optical disk to ensure the accuracy of data reading/writing. The main development trend in the industry is to enhance the competitiveness of optical disk drive products by actively miniaturizing and lowering the manufacture cost while improving the precision of the gearing mechanism.

FIG. 1 shows a conventional gearing mechanism 10 for the pick-up head of an optical disk drive. The gearing mechanism 10 rotates a screw 12 by a gearing motor 11. The body 13 enhances the structural strength by multiple structures 14 for securely connecting with the sled (not shown) carrying the pick-up head. A toothed frame 15 protrudes from the front end of the body 13. Two slanted parallel racks 16 are disposed on the upper surface of the front end of the toothed frame 15. One end of an elastic plate 17 is fixed on the bottom of the front end of the body 13, while the other end sticks out of the body 13 and is located underneath the toothed frame 15 next to the lower surface of the toothed frame 15. As a result, the toothed frame 15 is provided with sufficient elasticity when the gearing motor 11 rotates the screw 12 rapidly, whereby pushing the racks 16 to engage with the screw thread 18 of the screw 12, preventing the rotating screw 12 from pushing off the racks 16 and causing slip of the racks 16 which may further affect the precision of positioning the pick-up head by the body 13.

However, the body 13 of the conventional gearing mechanism 10 for the pick-up head of an optical disk drive not only has a complex structure which is difficult to be manufactured, but also consists of many components that waste time on manufacturing/assembly and component cost. In addition, the two racks 16 of the conventional gearing mechanism 10 for the pick-up head of an optical disk drive are disposed on the outside of the toothed frame 15 together. When one rack 16 is pushed off the chute of the screw thread 18 due to the fast rotation of the screw 12, the other rack 16 that also takes the fixing end of the toothed frame 15 and the elastic plate 17 as a bending pivot will be pushed off the chute of the screw thread 18 as well, causing slip of the racks and failure in power transmission to maintain the precision of positioning the pick-up head by the body 13. Hence there are still problems to be solved on the conventional rack structure in an optical disk drive.

### SUMMARY OF THE INVENTION

An objective of the present invention is to provide a rack structure in an optical disk drive, which reduces time on manufacturing/assembly and component cost by forming the rack structure integrally to enhance product competitiveness.

Another objective of the present invention is to provide a rack structure in an optical disk drive, wherein the rack structure is assembled rapidly with the rack structure formed by metal pressing along with the connecting part of the pick-up head to enhance the precision of gearing.

A further objective of the present invention is to provide a rack structure in an optical disk drive, wherein a reinforcement is formed integrally in the rack structure for enhancing the plate strength of the rack structure, so as to provide the elasticity for pushing the rack.

A still further objective of the present invention is to provide a rack structure in an optical disk drive, wherein racks with complementary bending pivots are formed for the rack structure, so that when one rack is pushed off, the other rack will be pushed tight against the screw spontaneously, whereby maintaining the regular power transmission.

A still further objective of the present invention is to provide a rack structure in an optical disk drive, wherein a stopper is formed on the front end of the body to enhance the elasticity of the engagement of the rack nearby and to strengthen the pivot of leverage for the rack to engage with the screw spontaneously, so as to maintain the power transmission.

In order to achieve the foregoing objectives of the invention, the rack structure in an optical disk drive according to the present invention is formed integrally by pressing a metal plate; a connecting fixing part is disposed on a body; a brace is formed by bending down a periphery of the body; a convex or a concave trench is pressed near a front end of the body to form a secondary reinforcement; a reinforcement is formed by bending down near the middle of the front end of the body, an elastic support is extended from the front end of the reinforcement and bent parallel to the front end of the body; a space is maintained between the elastic support and the body; a horizontal slot is pressed in the middle of the elastic support to form an upper support and a lower support; a first rack is disposed on one end connecting the upper support, of the lower support; the other end of the lower support is extended from the reinforcement to form a bending pivot; and a second rack is formed on the other end of the tipper support.

The optical disk drive equipped with the rack structure according to the present invention rotates a screw by a gearing mechanism using a gearing motor to drive a screw thread. A guiding pole is disposed next to the screw in parallel. A connecting part is disposed on the pick-up head and sleeves the guiding pole. The rack structure is formed integrally by pressing. A fixing part is disposed on the body for fixed connection with the connecting part. The front end of the body is bent down to form a reinforcement. An elastic support is extended from the front end of the reinforcement and bent parallel to the front end of the body. A space is maintained between the elastic support and the body. At least one rack is formed on the elastic support, so the elastic support is supported by the reinforcement and sticks out of the connecting part, causing the rack to engage with the screw thread.

### BRIEF DESCRIPTION OF THE DRAWINGS

FIG. 1 is an exploded view showing the parts of the conventional gearing mechanism for the pick-up head of an optical disk drive;.

FIG. 2 is a perspective view of the rack structure according to the first embodiment of the present invention;

FIG. 3 is a perspective view showing the assembly of the rack structure according to the first embodiment of the present invention;

FIG. 4 is a perspective view of the rack structure according to the second embodiment of the present invention;

FIG. 5 is a schematic view showing the action of the rack structure according to the second embodiment of the present invention;

FIG. 6 is a perspective view of the rack structure according to the third embodiment of the present invention;

FIG. 7 is a perspective view of the rack structure according to the fourth embodiment of the present invention; and

FIG. 8 is a perspective view of the rack structure according to the fifth embodiment of the present invention.

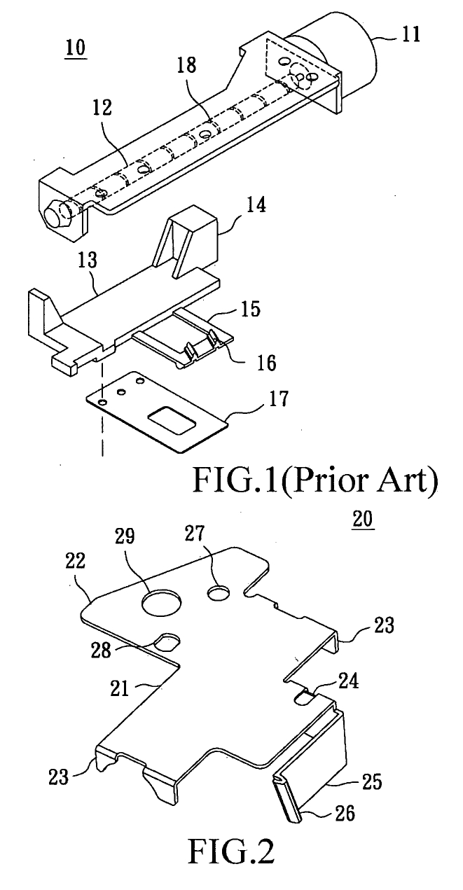

### DETAILED DESCRIPTION OF THE INVENTION

The techniques employed by the present invention to achieve the foregoing objectives and the effects thereof are described hereinafter by way of examples with reference to the accompanying drawings.

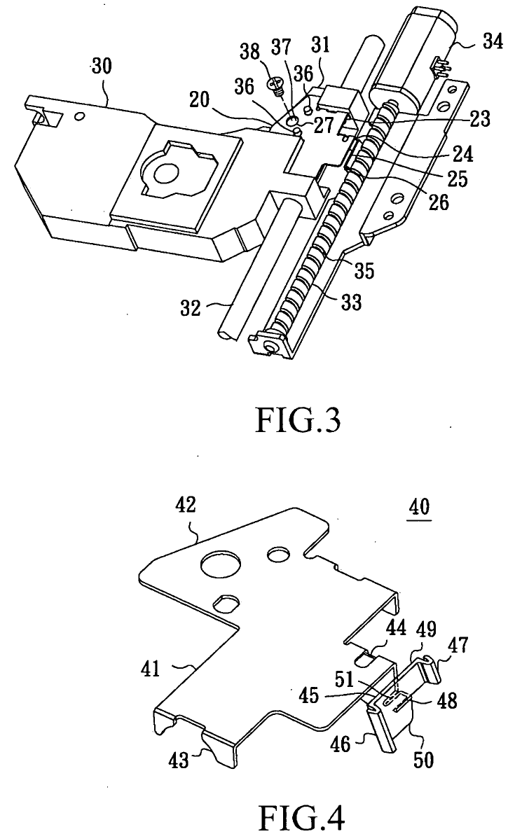

FIG. 2 shows a rack structure 20 in an optical disk drive according to the first embodiment of the present invention. The rack structure 20 is formed integrally by pressing a metal plate and includes a body 21, a fixing part 22, braces 23, a reinforcement 24, an elastic support 25, and a rack 26. Generally, the elastic support 25 is extended from the reinforcement 24 located on the front end of the body 21. The rack 26 is disposed on the elastic support 25. The braces 23 are formed on the laterals of the body 21. The rack structure 20 forms connection with the connecting part 31 of the pick-up head 30 by the fixing part 22 in the back of the body 21 (see FIG. 3).

The body 21 is flat for being fixed to the connecting part 31 of the pick-up head 30, and the shape thereof may vary with the shape of the connecting part 31 of the pick-up head 30 to match with each other. The fixing part 22 is disposed in the back of the body 21 and formed with a plurality of holes by punch pressing the body 21 as a connecting structure. The plurality of holes includes a positioning hole 27, an adjusting hole 28, and a fixing hole 29. The positioning hole 27 is circular for forming relative positioning to the connecting part 31. The adjusting hole 28 is a slightly elongated circular hole for adjusting the positioning error relative to the connecting part 31 for easy assembly. The fixing hole 29 is a circular hole with a greater diameter for forming connection with the connecting part 31. The braces 23 are formed by bending down several legs in the periphery of the body 21, which are mainly used for leaning against the connecting part 31 laterally to enhance the horizontal support of the rack structure 20. The braces 23 may also be formed by bending down several legs of different heights on the connecting part 31 in accordance with the height drop of the connecting part 31, so as to provide the rack structure 20 with vertical support.

In addition, the reinforcement 24 is formed by bending down near the middle of the front end of the body 21. The reinforcement 24 is substantially perpendicular to the body 21 for reinforcing the structural strength in the middle of the flat body 21. The elastic support 25 is extended from the front end of the reinforcement 24 and bent substantially parallel to the front end of the body 21 along the direction in which the reinforcement 24 is perpendicular to the body 21. A space is maintained between the elastic support 25 and the body 21 for allowing free swing of the elastic support 25. Further, the rack 26 is formed by pressing the front end of the elastic support 25 substantially in a vertical direction, and the surface of the rack faces the outside of the front end of the body 21. The elastic support 25, however, may also be bent to adjust the direction of the engagement of the rack 26.

FIG. 3 shows the rack structure 20 in an optical disk drive according to the first embodiment of the present invention mounted on the gearing mechanism for the pick-up head 30. A connecting part 31 is disposed on one side of the pick-up head 30 and sleeves a guiding pole 32 for sliding. A screw 33 is disposed on the side near the guiding pole 32 in parallel. One end of the screw 33 is rotated by a gearing motor 34 to drive the screw thread 35 on the screw 33. Basically, the connecting part 31 is a lower container. Two positioning pins 36 and tapped holes 37 are disposed in the back away from the chute of the screw 33.

Referring to FIG. 2 and FIG. 3 simultaneously, since the shape of the rack structure 20 according to the present invention is formed by pressing in accordance with the shape of the container on the connecting part 31, upon assembly, the positioning hole 27 and the adjusting hole 28 are aligned with the two positioning pins 36 respectively, and the positioning pins 36 are easily inserted into the positioning hole 27 to accomplish the positioning under the allowable error of the adjusting hole 28, so that the rack structure 20 is installed in the connecting part 31 correctly. The braces 23 securely lean against the lateral edges of the connecting part 31. The fixing hole 29 is aligned with the tapped holes 37 by the bolt 38 to screw the rack structure 20 onto the connecting part 31 such that the reinforcement 24, the elastic support 25, and the rack 26 stick out of the connecting part 31. The elastic support 25 is supported by the reinforcement 24, and the elasticity of the elastic support 25 is utilized to push the rack 26 to engage with the screw thread 35 of the screw 33. The screw 33 is rotated clockwise/counterclockwise by the gearing motor 34, causing the rack 26 to move back and forth along the screw thread 35. The pick-up head 30 is driven by the rack structure 20.

As a result, the rack structure in an optical disk drive according to the first embodiment of the present invention may manufacture multiple components by pressing once in accordance with the rack structure formed integrally by metal pressing, which not only enhances the competitiveness of optical disk drive products by reducing time on manufacturing/assembly of the rack structure and component cost, but also securely fixes the rack structure along with the connecting part of the pick-up head, as well as improving the structural strength of the rack by the reinforcement formed integrally in the rack structure to provide the elasticity of pushing the rack, whereby achieving the purpose of enhancing the precision of gearing.

FIG. 4 shows a rack structure 40 in an optical disk drive according to the second embodiment of the present invention. The rack structure 40 includes a body 41, a fixing part 42, braces 43, a reinforcement 44, an elastic support 45, and a rack 46, which are substantially identical to those of the rack structure in the first embodiment of the present invention. The difference is, in this embodiment, a second rack 47 is pressed on the other end of the elastic support 45 opposite to the first rack 46. A horizontal slot 48 is pressed in the middle of the elastic support 45, which causes the elastic support 45 to become a supine U-shape divided into an upper support 49 and a lower support 50. The first rack 46 is disposed on one end connecting the upper support 49 and the lower support 50, while the other end of the lower support 50 is extended from the reinforcement 44. A crease 51 is formed on the lower support 50 for enhancing support and adjusting the space between the elastic support 45 and the body 41, as well as causing the lower support 50 to support the elastic support 45 in the middle. The second rack 47 is pressed on the other end of the upper support 49.

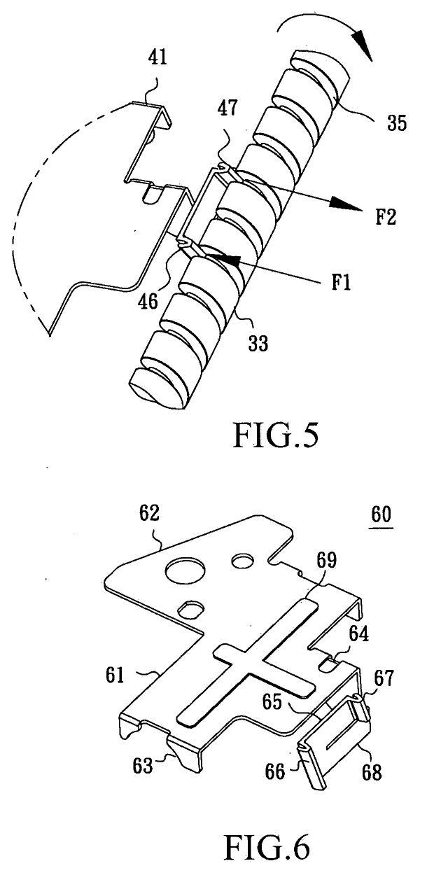

The rack structure 40 may be formed integrally by pressing metal to reduce time on manufacturing/assembly of the rack structure and component cost in this embodiment. Referring to FIG. 4 and FIG. 5 simultaneously, in which FIG. 5 shows the gearing carried out by the rack structure 40 of this embodiment engaging with the screw 33. In this embodiment, pressing two racks for the rack structure 40 may not only improve the engagement but also the first rack 46 is pushed off the screw thread 35 in the direction shown by the force F1 when the screw 33 rotates clockwise (as shown by the arrow) due to the direction of the chute of the screw thread 35. Since the lower support 50 supports the elastic support 45 in the middle, when the first rack 46 is forced to come off the screw thread 35, the bending pivot thereof is located in the middle of the elastic support 45, and the first rack 46 coming off the screw thread 35 causes the elastic support 45 to bend simultaneously; As a result, the second rack 47 on the other end of the elastic support 45 obtains greater elasticity in the direction shown by the force F2, whereby pushing the second rack 47 to engage with the screw thread 35 for preventing slip of the rack. On the contrary, when the screw 33 rotates counterclockwise, the second rack 47 forced to come off the screw thread 35 takes the middle of the elastic support 45 as a bending pivot and counter-pushes the first rack 46 to engage with the screw thread 35.

Accordingly, in the rack structure 40 in an optical disk drive according to the second embodiment of the present invention, a rack is pressed on both ends of the elastic support 45 respectively, and a bending pivot is formed using the middle of the U-shaped elastic support 45, so that among the racks having complementary force, when one rack is pushed off, the other rack will be pushed tight against the screw spontaneously, whereby maintaining the regular power transmission of the gearing mechanism of the pick-up head.

FIG. 6 shows a rack structure 60 in an optical disk drive according to the third embodiment of the present invention. The rack structure 60 in this embodiment includes a body 61, a fixing part 62, braces 63, a reinforcement 64, an elastic support 65, a first rack 66, and a second rack 67, which are substantially identical to those of the rack structure in the second embodiment of the present invention. The difference is, in this embodiment, no crease is formed on the lower support 68 of the U-shaped elastic support 65, but one end of the elastic support 65 is directly bent, and a secondary reinforcement 69 is formed on the body 61. The lower support 68 is bent on one end of the elastic support 65, which may simplify the manufacturing process of the rack structure 60. And the elasticity from deformation of the elastic support 65 being bent when the first rack 66 or the second rack 67 is forced to come off the screw thread is utilized to counter-push the opposite rack for enhancing the engagement with the screw thread.

In addition, the secondary reinforcement 69 is pressed near the front end of the body 61 in this embodiment. The secondary reinforcement 69 may be a convex or a concave trench formed by pressing. In this embodiment, the secondary reinforcement 69 is formed in the shape of a cross to enhance the structural strength of the flat rack structure 60, which not only provides the rack structure 60 with greater strength to support the pick-up head moving rapidly, but also provides the elastic support 65 sticking out with better support to improve the reliability of engagement.

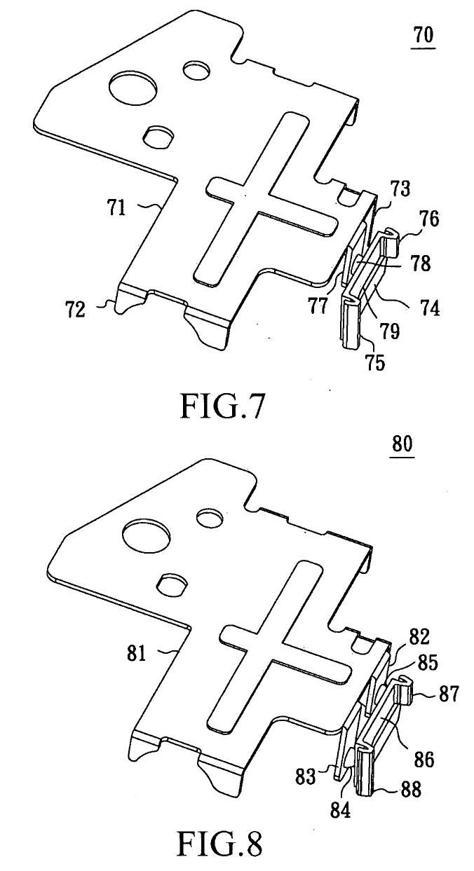

FIG. 7 shows a rack structure 70 in an optical disk drive according to the fourth embodiment of the present invention. The rack structure 70 in this embodiment includes a body 71, braces 72, a reinforcement 73, an elastic support 74, a first rack 75, and a second rack 76, which are substantially identical to those of the rack structure in the third embodiment of the present invention. The difference is, in this embodiment, a stopper 77 is fixed on the front end of the body 71, and the stopper 77 may be extended from the front end of the body 71 and formed integrally by being bent down, as well as located in the back of the elastic support 74. A stud 78 is pressed outward on the stopper 77. The stud 78 may be hemispherical. The stud 78 substantially bulges in the middle of the back of the upper support 79, which causes the stud 78 to form a seesaw pivot between the first rack 75 and the second rack 76 on both ends of the upper support 79.

When the first rack 75 or the second rack 76 is pushed off the screw thread, the stud 78 of the stopper 77 may lean against the upper support 79 to enhance the elasticity of the rack engaging with the screw. In the meantime, a rack is pushed off the screw thread. One end of the upper support 79 may also be pushed to force the other end of the upper support 79 to countermove and engage with the screw thread in accordance with the leverage using the pivot of the stud 78, whereby providing the rack structure 70 with greater reliability of engagement.

FIG. 8 shows a rack structure 80 in an optical disk drive according to the fifth embodiment of the present invention. The rack structure 80 in this embodiment is substantially identical to the rack structure in the fourth embodiment of the present invention. The difference is, in this embodiment, two stoppers 82, 83 are fixed on the front end of the body 81, and the studs 84, 85 on the stoppers 82, 83 face the upper support 86 respectively, as well as being located on the inside of the first rack 87 and the second rack 88.

When the first rack 87 or the second rack 88 is pushed off the screw thread, the studs 84, 85 of the stoppers 82, 83 may lean against the upper support 86 respectively to enhance the elasticity of each rack engaging with the screw nearby. In the meantime, a rack is pushed off the screw thread. One end of the upper support 86 may also be pushed to force the other end of the upper support 86 to countermove and engage with the screw thread in accordance with the leverage using the pivots of the studs 84, 85, whereby providing the rack structure 80 with greater reliability of engagement.

Accordingly, the rack structure in an optical disk drive according to the present invention may enhance the elasticity of the engagement of the rack by the stopper formed in the front of the body using the pivot of stud nearby, and strengthen the leverage of the upper support to push the two racks against each other, whereby achieving the purpose of engaging with the screw spontaneously.

The preferred embodiments of the present invention have been disclosed in the examples. However the examples should not be construed as a limitation on the actual applicable scope of the invention, and as such, all modifications and alterations without departing from the spirits of the invention and appended claims shall remain within the protected scope and claims of the invention.

What is claimed is:

1. A rack structure in an optical disk drive formed integrally by pressing a metal plate, comprising:
a body;
a fixing part disposed on the body as a connecting structure;
a reinforcement formed by bending down near the middle of the front end of the body;
an elastic support extended from a front end of the reinforcement and bent parallel to the front end of the body along direction of the reinforcement, a space being maintained between the elastic support and the body; and
at least one rack disposed on the elastic support.

2. The rack structure in an optical disk drive according to claim 1, wherein the body further comprises a brace formed by bending down the periphery of the body.

3. The rack structure in an optical disk drive according to claim 1, wherein the rack is formed by pressing the end of the elastic support and the surface of the rack faces outside of the front end of the body.

4. The rack structure in an optical disk drive according to claim 1, wherein a convex or a concave trench is pressed near the front end of the body to form a secondary reinforcement.

5. The rack structure in an optical disk drive according to claim 1, wherein a horizontal slot is pressed in the middle of the elastic support to form an upper support and a lower support, a first rack being disposed on one end connecting the upper support, of the lower support, the other end of the lower support being extended from the reinforcement, and a second rack being formed on the other end of the upper support.

6. The rack structure in an optical disk drive according to claim 5, wherein the lower support forms a bending pivot by bending one end of the lower support near the elastic support.

7. The rack structure in an optical disk drive according to claim 5, wherein the lower support forms a bending pivot by bending the lower support in the middle of the elastic support.

8. The rack structure in an optical disk drive according to claim 1, wherein at least one stopper is fixed on the front end of the body, and a stud bulges on the stopper in the back of the elastic support.

9. The rack structure in an optical disk drive according to claim 8, wherein a stopper is fixed on the front end of the body, and the stud is located in the middle of the back of the elastic support.

10. The rack structure in an optical disk drive according to claim 9, wherein the stud is located in the back of the elastic support near the inside of the rack.

11. The rack structure in an optical disk drive according to claim 8, wherein the stud is hemispherical.

12. An optical disk drive, comprising:
a gearing mechanism which rotates a screw by a gearing motor to drive a screw thread, a guiding pole being disposed next to the screw in parallel;
a pick-up head provided with a connecting part and sleeving the guiding pole; and
a rack structure formed integrally by pressing, including a body on which a fixing part is disposed for fixed connection with the connecting part, a front end of the body being bent down to form a reinforcement, an elastic support being extended from a front end of the reinforcement and bent parallel to the front end of the body, a space being maintained between the elastic support and the body, at least one rack being formed on the elastic support, the elastic support being supported by the reinforcement and sticking out of the connecting part, causing the rack to engage with the screw thread.

13. The optical disk drive according to claim 12, wherein a positioning hole, an adjusting hole, and a fixing hole are formed on the fixing part for secure connection with two positioning pins and tapped holes disposed on the connecting part by a bolt.

14. The optical disk drive according to claim 12, wherein the body further comprises a brace formed by bending down a periphery of the body and leaning against a lateral edge of the connecting part.

15. The optical disk drive according to claim 12, wherein a convex or a concave trench is pressed near the front end of the body to form a secondary reinforcement.

16. The optical disk drive according to claim 12, wherein a horizontal slot is pressed in the middle of the elastic support to form an upper support and a lower support, a first rack being disposed on one end connecting the upper support, of the lower support, the other end of the lower support being extended from the reinforcement, and a second rack being formed on the other end of the upper support.

17. The optical disk drive according to claim 16, wherein the lower support forms a bending pivot by bending one end of the lower support near the elastic support.

18. The optical disk drive according to claim 12, wherein at least one stopper is fixed on the front end of the body, and a stud bulges on the stopper in the back of the elastic support.

19. The optical disk drive according to claim 18, wherein a stopper is fixed on the front end of the body, and the stud is located in the middle of the back of the elastic support.

20. The optical disk drive according to claim 18, wherein the stud is located in the back of the elastic support near the inside of the rack.
